(19) United States
(12) Patent Application Publication
(10) Pub. No.: US 2002/0143708 A1
(43) Pub. Date: Oct. 3, 2002

(54) System and method for conducting secure on-line transactions using a credit card

(76) Inventors: Harvey Hollander, Brooklyn, NY (US); David Zeng, Flushing, NY (US)

Correspondence Address: Jean-Marc Zimmerman, 226 St. Paul Street, Westfield, NJ, 07090, US

(21) Appl. No.: 09/871,278

(22) Filed: May 31, 2001

Related U.S. Application Data
(60) Provisional application No. 60/279,159, filed on Mar. 27, 2001.

(51) Int. Cl. G06F 17/60; H04K 1/00; H04L 9/00; G06K 5/00

(52) U.S. Cl. 705/72; 235/379; 235/380; 705/39

(57) ABSTRACT

A system and method for conducting secure credit card transactions over the Internet, wherein the system and method are implemented using software which selectively switches a computer modem from the Internet to a secure telephone line and free standing server and then back to the Internet. When a consumer is ready to make a purchase from a web site, their Internet connection to the site is temporarily disconnected and the consumer is simultaneously switched to a secure telephone line connection to a server operated by the applicant. The details regarding the purchase, such as item being purchased, purchase price and merchant identity are automatically provided to the server. The consumer is then prompted to enter a pre-registered PIN which together with the phone number from which the consumer is calling are used by the server to verify the identity of the consumer. After the identity of the consumer has been verified, the server electronically transmits the purchase details to a MSP which in turn electronically transmits this information to the appropriate credit card company who authorizes or denies the purchase. Once the purchase is authorized or denied, the consumer is switched back to the web site, and the purchase authorization or denial is communicated to the site operator so that any authorized purchase can be processed.

### PRIORITY NOTICE

This Non-Provisional U.S. Patent Application claims the benefit of the Mar. 27, 2001 filing date of Provisional U.S. Patent Application Serial No. 60/279,159.

### FIELD OF THE INVENTION

The present invention relates to systems and methods for conducting electronic commerce over a computer network, and more particularly to a system and method for doing so in a secure manner.

### BACKGROUND OF THE INVENTION

Conducting commercial transactions electronically over computer networks such as the Internet is commonplace today. Consumers typically pay for such electronic purchases by means of a credit card, wherein after the consumer accesses a merchant's web site and selects the goods and/or services to be purchased, they then provide the web site operator with information, such as their name, credit card number and card expiration date. The web site then communicates electronically with a merchant service provider (MSP), such as an acquiring bank or an independent service organization. The MSP in turn communicates over an asynchronous network 26 with the bank or other financial entity which issued the card (credit card issuer) to obtain authorization to process the consumer's purchase. The approval or denial of purchase authorization is then communicated to the web site which advises the consumer of the same.

The communications between the consumer's computer/server and the web site's server, and between the web site's server and the MSP server are typically conducted over non-secure lines that are vulnerable to attack by hackers who can intercept such communications and obtain, i.e., steal, the consumer's credit card information to make unauthorized purchases. This vulnerability is of concern both to consumers and to web site operators since fewer consumers are likely to make on-line purchases if they fear their credit card information can be easily stolen, which will in turn adversely impact the likely commercial success of such web sites.

Conventional techniques employed to provide greater security to such transactions and thereby thwart the illicit activities of hackers typically rely on encrypting such communications, wherein confidential financial information, such as a consumer's credit card number, communicated between any two parties is scrambled into an unrecognizable form. Although encryption can be accomplished in different ways, most encryption systems employed over the Internet utilize two-way encryption techniques in which communications between such parties are encrypted in both directions between the parties.

Conventional systems of the type described above for transacting on-line credit card purchases suffer from a drawback. Specifically, such systems are vulnerable to attack by hackers whether they encrypt communications or not. Accordingly, it is an object of the present invention to provide a secure system and method for making on-line purchases using a credit card that does not require that a consumer electronically provide their credit card information to an on-line web site.

### SUMMARY

A system and method for making on-line purchases using a credit card, wherein the system and method are implemented using software that selectively switches a consumer's computer connection from a merchant's web site on the Internet to a secure telephone line for accessing a free standing server used to obtain authorization from a MSP to make a purchase, and then switches the consumer back to the web site once such authorization is obtained or denied. The invention operates such that when a consumer is ready to make a purchase from the web site, their Internet connection to the site is temporarily disconnected and they are switched to a secure telephone line connection to access a server operated by the applicant. Details regarding the purchase, such as item, price and the identity of the merchant, are automatically provided to this server. The consumer is then prompted to enter a pre-registered identifying number, such as a personal identification number (PIN), which together with the telephone number the consumer calls from are used by the applicant's server to identify the consumer. The consumer is also prompted to enter digits from their credit card number to identify the card issuer so that purchase authorization can be obtained from the issuer. After the identity of the consumer is authenticated, the applicant's server transmits the purchase details to the MSP who obtains authorization or denial of the purchase from the appropriate credit card issuer. After the purchase is authorized or denied, the present invention switches the consumer back to the page of the web site the consumer was previously viewing and advises the web site operator whether the purchase was authorized or not Authorized purchases are then processed by the web site.

### BRIEF DESCRIPTION OF THE DRAWINGS

FIG. 1 shows a block diagram depicting an exemplary embodiment of a system for conducting on-line credit card transactions according to the present invention.

FIG. 2 shows a flowchart depicting the steps in the operation of the system shown in FIG. 1.

### DETAILED DESCRIPTION OF THE INVENTION

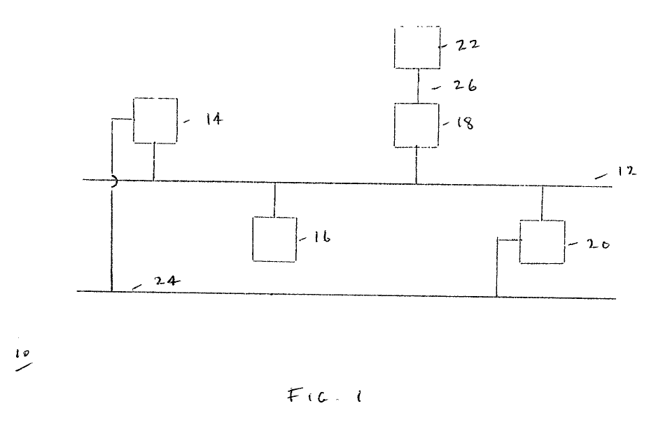

FIG. 1 shows a block diagram depicting an exemplary embodiment of a system 10 for conducting secure on-line credit card transactions according to the present invention. System 10 is comprised of Internet 12 to which are coupled a consumer's computer/server 14 having dial-up connection to Internet 12, a server 16 for a merchant's web site, a MSP's server 18 and a remote server 20 operated by the applicant or an other entity that provides the service for making secure on-line credit card purchases according to the present invention. System 10 is also comprised of a credit card issuer's server 22 which is coupled to server 18 via an asynchronous network 26. Computer/server 14, server 16, server 18 and server 20 and server 22 can each be any type of electronic device capable of receiving, storing and/or transmitting information, or can alternatively, be electronic devices such as routers and/or switches. System 10 also includes a secure telephone line 24 to which computer/server 14 and server 20 are coupled. Line 24 can be a toll free line or a toll line.

Computer/server 14, server 16, server 18, server 20 and server 22 each include an associated display device, e.g., monitor, and a communications means, e.g., modem, for accessing and communicating over a communication line. System 10 can include any number of consumer computer/servers 14, merchant servers 16, MSP servers 18, remote servers 20 and/or credit card issuer servers 22. Any type of consumer including, but not limited to, individuals, businesses, governmental entities and schools can use system 10.

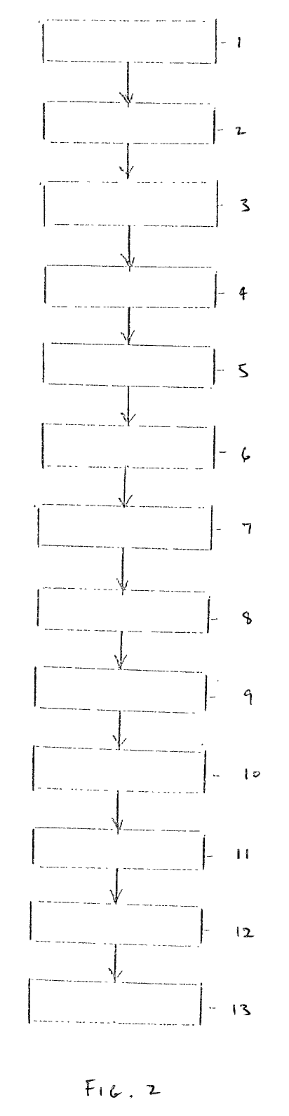

FIG. 2 shows a flowchart depicting the operation of the present invention. At step 1, a consumer accesses the merchant's web site on server 16 from computer/server 14. At step 2, the consumer browses the merchant's web site and selects those products and/or services to be purchased by adding them to a “shopping basket”. At step 3, the consumer pays for their purchase by selecting a payment button displayed on the merchant's web site. Doing so, initiates at step 4, a secure telephone call from computer/server 14 to remote server 20 over secure telephone line 24 while simultaneously disconnecting the Internet 12 connection between computer/server 14 to server 16. It also causes a display box to be displayed on the display device associated with computer/server 14 that requests that the consumer provide their PIN and a plurality of digits, e.g., four, the credit card the consumer is going to use for the purchase. The first four digits of a credit card identify the credit card issuer. The applicant or entity operating server 20 uses the PIN and telephone number from which the consumer calls to verify the identity of the consumer. Server 20 uses software, i.e., caller identification software, to determine the telephone number from which the consumer is calling. The consumer will have previously registered the PIN and telephone number with the applicant or operator of server 20, the MAP and/or the credit card issuer via fax, mail or telephone. The PIN can be selected by the consumer, or alternatively it can be selected for the consumer by the applicant, the MSP or the credit card issuer. A consumer can register more than one telephone number so that they can use the present invention from each of the registered telephone numbers.

At step 5, the consumer provides the requested information. At step 6, server 20 authenticates the identity of the consumer based on the PIN and the telephone line number from which the consumer is calling. At step 7, server 20 transmits the identifying information together with information regarding the purchase, such as the credit card being used, the item being purchased, the purchase price and the merchant identity, to server 18 via Internet 12. Server 20 can also transmit this information to server 18 via a telephone line or a lease line. At step 8, server 18 transmits the foregoing information via asynchronous network 26 to server 22 to obtain credit card authorization for the purchase. Alternatively, rather than having server 20 authenticate the identity of the consumer, server 20 can transmit the PIN and consumer telephone number through to server 18 or server 22 for authentication of the consumer's identity.

At step 9, server 22 either authorizes or denies the purchase and transmits the authorization code or denial to server 18 which in turn transmits said information to server 20. In response, at step 10, the consumer receives a message on the display device associated with computer/server 14 to select a continue button. Doing so, causes at step 11, server 20 to disconnect consumer computer/server 14 from the secure telephone line 24 to server 20, and to reconnect computer/server 14 to server 16. Server 20 calls the consumer's Internet service provider to reconnect computer/server 14 to server 16. It also results in either the authorization code number being provided to the merchant so that the purchase can be processed, or in the denial being communicated to the merchant.

At step 12, the consumer is reconnected to the page of the merchant's web site which the consumer was viewing prior to being switched to secure telephone line 24. At step 13, the consumer completes the transaction on the merchant's web site by terminating the connection to server 16. In an alternative embodiment of the present invention, the consumer will not have to select a continue button at step 10, but will instead be simultaneously disconnected from secure telephone line 24 and reconnected to server 16 once purchase authorization is obtained or denied by the credit card issuer.

When a consumer calls from an extension number of a registered trunk line telephone number, then in addition to providing at step 4 both their previously registered PIN and the first four digits of their credit card number, they will also have to provide the last four digits of their social security number. At step 6, server 20 will use the PIN, the trunk line telephone number and the last four digits of the consumer's social security number to authenticate the identity of the consumer. Like their PIN, the consumer will have previously registered the last four digits of their social security number with the applicant, the MSP and/or the credit card issuer.

An alternative embodiment of the present invention can be used where the consumer has a broadband connection to Internet 12, such as a T-1 line or a digital subscriber line, rather than a dial-up modem connection. In such cases, the present invention operates as previously described above except with respect to the steps performed to authenticate the identity of a consumer. Specifically, since there is no dial tone and thus no telephone number for server 20 to detect and use to verify the identity of the consumer using a broadband connection, steps 4-6 described above are replaced with the four steps described below.

At step 4, a connection is established over Internet 12 through server 16 between server 14 and server 20. In response, at step 5, server 20 causes a toll free telephone number, an identifying challenge number and instructions for the consumer to follow to be displayed on the display device associated with computer/server 14. At step 6, the consumer follows the displayed instructions and uses their telephone to call the toll free number provided at step 5, and then uses the telephone key pad and/or voice commands to enter their PIN, a plurality of digits of their credit card number and the identifying challenge number in response to a series of prompts. The consumer will have previously registered both their PIN and the telephone number from which they place the call with the applicant, the MSP and/or the credit card issuer as previously described above. In response, at step 7, server 20 then authenticates the identity of the consumer based on the PIN and the challenge number. Thus, the broadband embodiment of the present invention will have one more operating step than the dial-up connection embodiment. However, the number of operating steps required in either embodiment can be varied, with steps being combined or separated as desired.

In another alternative embodiment of the present invention, a web site can offer the consumer the option of either making an on-line credit card purchase in the conventional manner by electronically providing their entire credit card number to the web site operator, or by instead using the invention described above.

The present invention is implemented using a single software program or a plurality of programs, e.g., modules, which program or modules can be written in many different languages. The software can include modules for automatically switching consumer computer/server 14 from Internet 12 to secure telephone line 24, and for disconnecting computer/server 14 from secure telephone line 24 and reconnecting computer/server 14 to merchant's server 16. The software can also include modules for authenticating the PIN number and telephone line number being used to contact server 20 before transmitting this information to credit card issuer server 22 for payment authorization. Additional modules also facilitate the control of transaction routing and the ledgering of transactions.

The present invention does not make the Internet secure or make data transmissions over the Internet secure. Rather, the invention eliminates the need for a consumer to provide their confidential credit card information over a network, i.e., the Internet, thereby reducing the amount of information that a consumer has to provide in order to obtain credit card authorization for an online purchase and minimizing the risk that such data will be stolen by a hacker. All credit card information remains with the credit card issuer and is not linked or interrogated by server 20. Credit card security is provided by the various combination of networks, i.e., telephone and computer, used to transmit the consumer's identifying information, but over which the consumer's credit card number is never transmitted.

A consumer can navigate a merchant's web site and/or select on-screen buttons using the present invention by clicking a mouse button, pressing a keyboard button, issuing verbal commands, using a touch-screen stylus, or otherwise. The present invention can be used on a global or local computer network, on a satellite-based network, on a personal computer, on a wireless telephone, on a wireless personal assistant such as a Palm Pilot@, or on any type of wired or wireless device that enables digitally stored information to be received and/or transmitted. Also, information displayed and viewed using the present invention can be printed, stored to other storage medium, and electronically mailed to third parties.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A system for making purchases on a network using a credit card, comprising:
means for selectively switching a first electronic device from a computer network to a secure telephone line and then back to the computer network, wherein the first electronic device is switched to the secure telephone network for connection to a second electronic device that can obtain authorization for a consumer using the first electronic device to make a credit card purchase on the computer network without having to electronically provide a credit card number over the computer network.

2. The system according to claim 1, wherein the means is a software program.

3. The means according to claim 1, wherein the means are a plurality of software programs.

4. The system according to claim 1, wherein the computer network is an Internet.

5. The system according to claim 1, wherein the first electronic device is a computer.

6. The system according to claim 1, wherein the second electronic device is at least one server.

7. The system according to claim 1, wherein the consumer uses the first electronic device to view a merchant web site on the computer network, the consumer being able to purchase goods and services from the merchant web site.

8. The system according to claim 1, wherein the consumer provides an identifying number to the second electronic device which the second electronic device uses to verify the identity of the consumer.

9. The system according to claim 1, wherein the consumer provides a plurality of digits from a credit card number to the second electronic device.

10. The system according to claim 1, wherein the second electronic device uses a telephone number from which the call over the secure telephone line is placed from the first electronic device to the second electronic device to verify the identity of the consumer.

11. The system according to claim 1, wherein the secured telephone line is a toll line.

12. The system according to claim 1, wherein the secure telephone line is a toll free line.

13. The system according to claim 8, wherein the identifying number is a personal identification number previously registered by the consumer with an entity operating the second electronic device.

14. The system according to claim 8, wherein the identifying number is comprised of a plurality of digits from a social security number previously registered by the consumer with an entity operating the second electronic device.

15. The system according to claim 10, wherein the telephone number is previously registered by the consumer with one selected from the group consisting of an entity operating the second electronic device, a MAP or a credit card issuer.

16. The system according to claim 1, wherein the means prompts the consumer to provide at least one identifying number once the first electronic device is coupled via the secure telephone line to the second electronic device.

17. The system according to claim 1, wherein after the consumer indicates their intention to purchase an item selected from a merchant web site, the means temporarily disconnects the first electronic device from the computer network and simultaneously connects the first electronic device to the second electronic device via the secure telephone line.

18. The system according to claim 17, wherein after the first electronic device is connected to the second electronic device, the means provides the second electronic device with information regarding the item the consumer seeks to purchase with the credit card.

19. The system according to claim 18, wherein after the second electronic device verifies the identity of the consumer, the second electronic device transmits both an identifying number that identifies the consumer and information regarding the item to be purchased to a third electronic device operated by a MSP to obtain authorization from a credit card issuer for the consumer to make the credit card purchase.

20. The system according to claim 18, wherein the second electronic device transmits both an personal identifying number that identifies the consumer and information regarding the item to be purchased to a third electronic device operated by a MSP to obtain authorization from a credit card issuer for the consumer to make the credit card purchase.

21. The system according to claim 20, wherein the third electronic device obtains authorization from a fourth electronic device operated by the credit card issuer.

22. The system according to claim 21, wherein the third electronic device is coupled to the fourth electronic device via an asynchronous network 26.

23. The system according to claim 21, wherein the third electronic device transmits both an identifying number that identifies the consumer and information regarding the item to be purchased to the fourth electronic device.

24. The system according to claim 1, wherein the identifying number is a personal identification number previously registered by the consumer with one selected from the group consisting of the entity operating the second electronic device, an MSP and a credit card issuer.

25. The system according to claim 1, wherein the third and the fourth electronic device communicate with one another via a telephone line.

26. The system according to claim 1, wherein the third and the fourth electronic device communicate with one another via a lease line.

27. The system according to claim 19, wherein the identifying number is pre-registered by the consumer with the entity operating the second electronic device.

28. The system according to claim 20, wherein the identifying number is pre-registered by the consumer with the MSP.

29. The system according to claim 20, wherein the identifying number is pre-registered by the consumer with the credit card issuer.

30. The system according to claim 20, wherein after the credit card issuer authorizes the purchase, the third electronic device transmits the authorization to the second electronic device which in turn transmits the authorization to the first electronic device.

31. The system according to claim 30, wherein after payment authorization is obtained from the credit card issuer, the consumer is prompted to select an on-screen continue button.

32. The system according to claim 31, wherein after the consumer selects the on-screen continue button, the first electronic device is disconnected from the secure telephone line to the second electronic device and is simultaneously reconnected to the merchant web site on the Internet.

33. The system according to claim 32, wherein when the first electronic device is reconnected to the merchant web site the second electronic device advises the merchant web site whether a credit card authorization was obtained so that the purchase can be processed.

34. The system according to claim 1, wherein when the first electronic device has a dial-up connection to access the second electronic device.

35. The system according to claim 1, wherein when the first electronic device has a broadband connection to the second electronic device.

36. The system according to claim 35, wherein when the second electronic device detects a communication from the first electronic device, the means causes a telephone number and an identifying challenge number to be displayed on a display device associated with the first electronic device.

37. The system according to claim 36, wherein the consumer calls the telephone number and enters the identifying challenge number in response to a prompt so that the second electronic device can authenticate the identity of the consumer.

38. A method for making purchases on a network using a credit card, comprising:
selectively switching a first electronic device from a computer network to a secure telephone line and then back to the computer network, wherein the first electronic device is switched to the secure telephone network for connection to a second electronic device that can obtain authorization for a consumer using the first electronic device to make a credit card purchase on the computer network without having to electronically provide a credit card number over the computer network.

39. The method according to claim 38, further comprising the step of prompting the consumer to provide at least one identifying number once the first electronic device is coupled via the secure telephone line to the second electronic device.

40. The method according to claim 38, further comprising the step of temporarily disconnecting the first electronic device from the computer network and simultaneously connecting the first electronic device to the second electronic device via the secure telephone line.

41. The method according to claim 40, further comprising the step of providing the second electronic device with information regarding the item the consumer seeks to purchase with the credit card.

42. The method according to claim 18, further comprising the step of transmitting both an personal identifying number that identifies the consumer and information regarding the item to be purchased from the second electronic device to a third electronic device operated by a MSP to obtain authorization from a fourth electronic device operated by a credit card issuer for the consumer to make the credit card purchase.

43. The method according to claim 42, further comprising the step of transmitting both an identifying number that identifies the consumer and information regarding the item to be purchased from the third electronic device to the fourth electronic device.

44. The method according to claim 38, wherein the identifying number is a personal identification number previously registered by the consumer with one selected from the group consisting of the entity operating the second electronic device, an MSP and a credit card issuer.

45. The method according to claim 42, further comprising the step of after the credit card issuer authorizes the purchase, the third electronic device transmits the authorization to the second electronic device which in turn transmits the authorization to the first electronic device.

46. The method according to claim 38, further comprising the step of when the second electronic device detects a communication from the first electronic device, the means causes a telephone number and an identifying challenge number to be displayed on a display device associated with the first electronic device.

47. The method according to claim 46, further comprising the step of the consumer calling the telephone number and entering the identifying challenge number in response to a prompt so that the second electronic device can authenticate the identity of the consumer.
